(19) United States
(12) Patent Application Publication
(10) Pub. No.: US 2022/0314406 A1
(43) Pub. Date: Oct. 6, 2022

(54) TOOL QUICK-RELEASE MECHANISM

(71) Applicant: Hong Ann Tool Industries Co., Ltd., Taichung City (TW)

(72) Inventor: Cheng-Wei SU, Taichung City (TW)

(21) Appl. No.: 17/671,833

(22) Filed: Feb. 15, 2022

(30) Foreign Application Priority Data
Apr. 1, 2021 (TW) 110112199

(51) Int. Cl. B25B 23/00

(52) U.S. Cl. CPC B25B 23/0035

(57) ABSTRACT

A tool quick-release mechanism includes a body having a guiding hole extending along a longitudinal axis, a control hole, and a coupling hole. Each of the control hole and the coupling hole intercommunicates with the guiding hole, extends in a radial direction perpendicular to the longitudinal axis, and extends through a sidewall of the body. A control member is movably received in the control hole. A coupling member is movably received in the coupling hole and is operatively connected to a guiding member movably received in the guiding hole. A biasing member is disposed between the guiding hole and the guiding member. When the control member moves in the control hole, the guiding member is actuated to resist a biasing force of the biasing member, and the coupling member selectively protrudes beyond the coupling hole in response to movement of the guiding member in the guiding hole.

### BACKGROUND OF THE INVENTION

The present invention relates to a tool mechanism and, more particularly, to a tool quick-release mechanism.

A tool coupler generally includes a ball and a spring for biasing the ball, such that the ball ca be releasably coupled with a tool, such as a socket. An example of such a tool coupler is illustrated in FIGS. 1-3 of Taiwan Patent Publication No. 201144627.

However, when the ball is coupled with a recess of the tool (i.e., the tool coupler is coupled with the tool), the ball can only be disengaged from the recess of the tool by a force applied by the user. Such a connection does not permit the user to apply the force easily. Furthermore, in a case that the ball is coupled in a deep position of the recess, it is difficult to disengage the ball from the recess even if a force is applied by the user. As a result, the user cannot easily disengage the tool from the tool coupler.

Thus, a need exists for a novel tool quick-release mechanism that mitigates and/or obviates the above drawbacks.

### BRIEF SUMMARY OF THE INVENTION

The technical problem to be solved by the present invention is incapability of quick release between the conventional coupler and the tool to be coupled.

Thus, the present invention provides a tool quick-release mechanism including a body and a connecting unit. The body includes a guiding hole extending along a longitudinal axis, a control hole intercommunicating with the guiding hole, and a coupling hole intercommunicating with the guiding hole. Each of the control hole and the coupling hole extends in a radial direction perpendicular to the longitudinal axis and extends through a sidewall of the body. The connecting unit includes a guiding member movably received in the guiding hole, a control member movably received in the control hole, a coupling member movably received in the coupling hole, and a biasing member disposed between the guiding hole and the guiding member. The control member is operatively connected to the guiding member. When the control member moves relative to the control hole, the guiding member resists a biasing force of the biasing member and moves relative to the guiding hole, and the coupling member selectively protrudes beyond the coupling hole in response to movement of the guiding member relative to the guiding hole.

In an example the control member is movable relative to the control hole in a direction parallel to the longitudinal axis and, thus, switchable between a coupling position and a release position. When the control member is in the coupling position, the coupling member protrudes beyond the coupling hole. When the control member is in the release position, the coupling member does not protrude beyond the coupling hole.

In an example, the guiding hole includes a smaller diameter section, a larger diameter section intercommunicating with the smaller diameter section, and a first shoulder formed between the smaller diameter section and the larger diameter section. The guiding member includes a smaller diameter portion, a larger diameter portion connected to the smaller diameter portion, and a second shoulder formed between the smaller diameter portion and the larger diameter portion. The biasing member includes two opposite ends abutting against the first shoulder and the second shoulder, respectively.

In an example, the biasing member is a coil spring mounted around the larger diameter portion of the guiding member.

In an example, the smaller diameter section of the guiding hole extends through a top wall of the body.

In an example, the guiding member includes a recessed portion defined in an outer periphery of the smaller diameter portion and abutting against the coupling member. The recessed portion includes a shallower section and a deeper section having a depth different from that of the shallower section. When the control member is in the coupling position, the coupling member abuts against the shallower section and protrudes beyond the coupling hole. When the control member is in the release position, the coupling member abuts against the deeper section and does not protrude beyond the coupling hole.

In an example, the larger diameter portion of the guiding member includes a first threaded portion extending in a radial direction perpendicular to the longitudinal axis. The control member includes an operating portion and a second threaded portion opposite to the operating portion. The second threaded portion is in threading connection with the first threaded portion, such that the control member is operable to actuate the guiding member to move relative to the guiding hole.

In an example, the operating portion is located outside of the control hole.

Thus, a user can simply move the control member of the tool quick-release mechanism according to the present invention with a finger to thereby switch the control member between the coupling position and the release position. When the control member is in the coupling position, the coupling member abuts against the shallower section and protrudes beyond the coupling hole for coupling with a recessed portion of a to-be-coupled tool. On the other hand, when the control member is in the release position, the coupling member abuts against the deeper section and does not protrude beyond the coupling hole, thereby disengaging from the recessed portion of the to-be-coupled tool, achieving the quick-release effect.

The present invention will become clearer in light of the following detailed description of illustrative embodiments of this invention described in connection with the drawings.

### DESCRIPTION OF THE DRAWINGS

FIG. 1 is a perspective view of a tool quick-release mechanism of an embodiment according to the present invention.

FIG. 2 is an exploded, perspective view of the tool quick-release mechanism of FIG. 1.

FIG. 3 is another exploded, perspective view of the tool quick-release mechanism of FIG. 1.

FIG. 4 is a cross sectional view of the tool quick-release mechanism of FIG. 1 with a control member in a coupling position.

FIG. 5 is a cross sectional view of the tool quick-release mechanism of FIG. 1 with the control member in a release position.

### DETAILED DESCRIPTION OF THE INVENTION

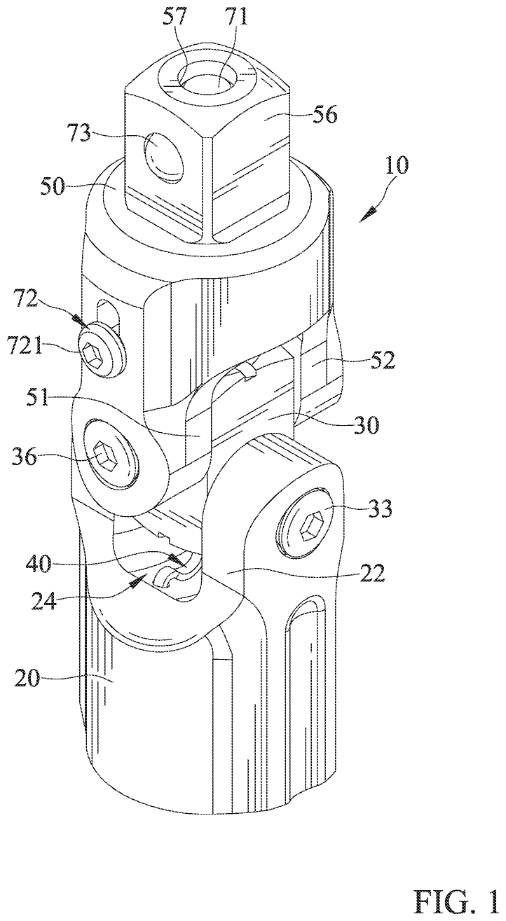

FIGS. 1-5 show a tool quick-release mechanism of an embodiment according to the present invention. The tool quick-release mechanism according to the present invention can be applied to a tool coupler 10, such that a to-be-coupled tool (such as a socket) can be quickly coupled to or disengaged from the tool coupler 10.

The tool quick-release mechanism includes a body 50 and a connecting unit 70. The body 50 includes a guiding hole 57 extending along a longitudinal axis L, a control hole 58 intercommunicating with the guiding hole 57, and a coupling hole 59 intercommunicating with the guiding hole 57. Each of the control hole 58 and the coupling hole 59 extends in a radial direction perpendicular to the longitudinal axis L and extends through a sidewall of the body 50. The connecting unit 70 includes a guiding member 71 movably received in the guiding hole 57, a control member 72 movably received in the control hole 58, a coupling member 73 movably received in the coupling hole 59, and a biasing member 74 disposed between the guiding hole 57 and the guiding member 71. The control member 72 is operatively connected to the guiding member 71. When the control member 72 moves relative to the control hole 58, the guiding member 71 resists a biasing force of the biasing member 74 and moves relative to the guiding hole 57, and the coupling member 73 selectively protrudes beyond the coupling hole 59 in response to movement of the guiding member 71 relative to the guiding hole 57.

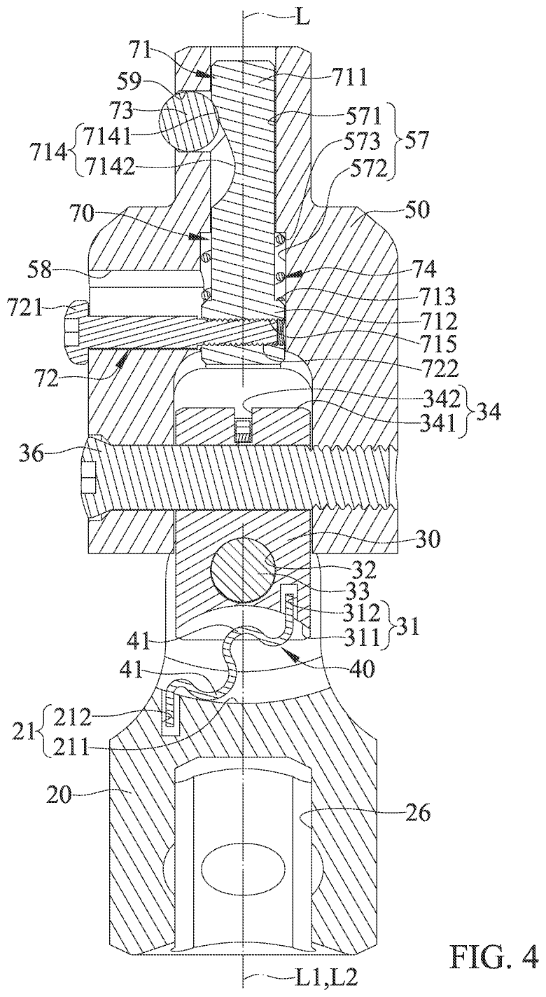

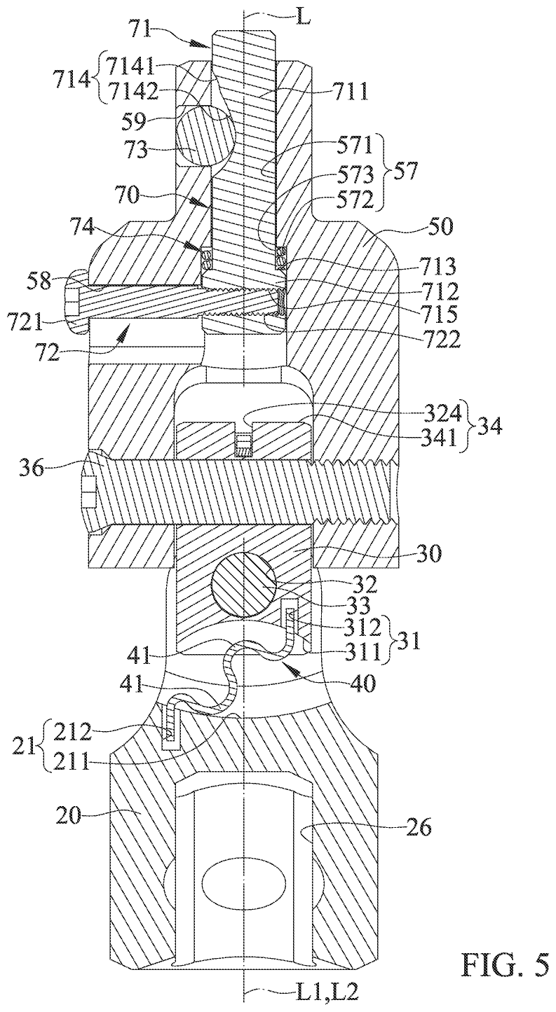

The control member 72 is movable relative to the control hole 58 in a direction parallel to the longitudinal axis L and, thus, switchable between a coupling position (FIG. 4) and a release position (FIG. 5). When the control member 72 is in the coupling position, the coupling member 73 protrudes beyond the coupling hole 59. When the control member 72 is in the release position, the coupling member 73 does not protrude beyond the coupling hole 59.

In order to permit action of the biasing force of the biasing member 74 on the guiding member 71, the guiding hole 57 includes a smaller diameter section 571, a larger diameter section 572 intercommunicating with the smaller diameter section 571, and a first shoulder 573 formed between the smaller diameter section 571 and the larger diameter section 572. The guiding member 71 includes a smaller diameter portion 711, a larger diameter portion 712 connected to the smaller diameter portion 711, and a second shoulder 713 formed between the smaller diameter portion 711 and the larger diameter portion 712. The biasing member 74 includes two opposite ends abutting against the first shoulder 573 and the second shoulder 713, respectively. In this embodiment, the biasing member 74 can be a coil spring mounted around the larger diameter portion 712 of the guiding member 71. The smaller diameter section 571 of the guiding hole 57 extends through a top wall of the body 50, such that the guiding member 71 protrudes beyond the top wall of the body 50 when the control member 72 is in the release position, as shown in FIG. 5.

In order to permit the coupling member 73 to selectively protrude beyond the coupling hole 59, the guiding member 71 includes a recessed portion 714 defined in an outer periphery of the smaller diameter portion 711 and abutting against the coupling member 73. The recessed portion 714 includes a shallower section 7141 and a deeper section 7142 having a depth different from that of the shallower section 7141. When the control member 72 is in the coupling position, the coupling member 73 abuts against the shallower section 7141 and protrudes beyond the coupling hole 59, as shown in FIG. 4. When the control member 72 is in the release position, the coupling member 73 abuts against the deeper section 7142 and does not protrude beyond the coupling hole 59, as shown in FIG. 5.

To permit actuation of the guiding member 71 by the control member 72, the larger diameter portion 712 of the guiding member 71 includes a first threaded portion 715 extending in a radial direction perpendicular to the longitudinal axis L. The control member 72 includes an operating portion 721 located outside of the control hole 58 and a second threaded portion 722 opposite to the operating portion 721. The second threaded portion 722 is in threading connection with the first threaded portion 715, such that the control member 72 is operable to actuate the guiding member 71 to move relative to the guiding hole 57. Thus, a user can simply move the operating portion 721 located outside of the control hole 58 with a finger to thereby switch the control member 72 between the coupling position and the release position. When the control member 72 is in the coupling position, the coupling member 73 abuts against the shallower section 7141 and protrudes beyond the coupling hole 59 (see FIG. 4) for coupling with a recessed portion of a to-be-coupled tool. On the other hand, when the control member 72 is in the release position, the coupling member 73 abuts against the deeper section 7142 and does not protrude beyond the coupling hole 59 (see FIG. 5), thereby disengaging from the recessed portion of the to-be-coupled tool, achieving the quick-release effect.

The tool coupler 10 to which this embodiment is applied may include a first connecting member 20, a second connecting member 30, and a first elastic element 40. The first connecting member 20 extends along a first rotational axis L1. The second connecting member 30 extends along a second rotational axis L2 and is pivotable relative to the first connecting member 20 between a first position and a second position. When the second connecting member 30 is in the first position, the first rotational axis L1 is coincident with the second rotational axis L2. When the second connecting member 30 is in the second position, the first rotational axis L1 and the second rotational axis L2 intersect each other and have an angle therebetween. The first elastic element 40 is disposed between the first connecting member 20 and the second connecting member 30. An end of the first elastic element 40 is securely connected to the first connecting member 20, whereas another end of the first elastic element 40 is securely connected to the second connecting member 30. The first elastic element 40 is a resilient plate, and at least one first bend 41 is formed between these two opposite ends of the first elastic element 40.

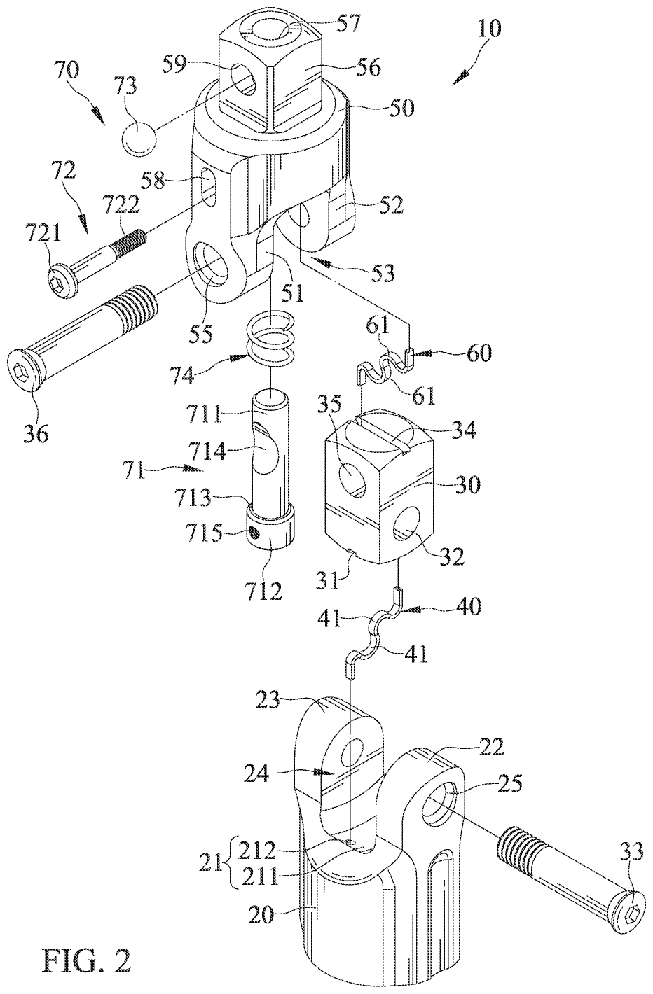

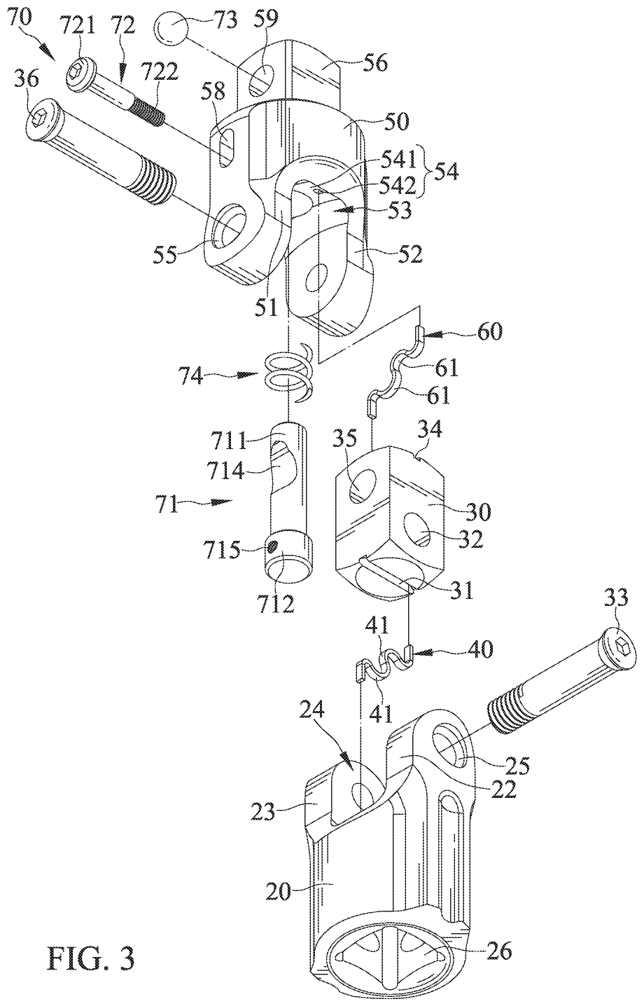

As shown in FIGS. 2 and 3, the first elastic element 40 may further include rectangular cross sections and may integrally form two first bends 41 through bending. The two first bends 41 are at different levels.

In order to permit the two opposite ends of the first elastic element 40 to be securely connected to the first and second connecting members 20 and 30, respectively, the first connecting member 20 includes a first groove 21. The first groove 21 includes a first groove bottom face 211 and a first connecting groove 212 in the first groove bottom face 211. An end of the second connecting member 30 adjacent to the first connecting member 20 includes a second groove 31. The second groove 31 includes a second groove bottom face 311 and a second connecting groove 312 in the second groove bottom face 311. The end of the first elastic element 40 is inserted into the first connecting groove 212, and the other end of the first elastic element 40 is inserted into the second connecting groove 312, thereby securely connecting the first elastic element 40 to the first and second connecting members 20 and 30.

Furthermore, each of the first groove bottom face 211 and the second groove bottom face 311 is arcuate. The curvature of the first groove bottom face 211 is smaller than the curvature of the second groove bottom face 311. One of the two first bends 41 abuts against the first groove bottom face 211, and another of the two first bends 41 selectively abuts against the second groove bottom face 311 in response to swaying movement of the second connecting member 30 relative to the first connecting member 20. Thus, a pneumatic tool can drive a socket while second connecting member 30 of the tool coupler 10 is in the second position (an oblique position). Due to the functionality of the first elastic element 40, the second connecting member 30 can move towards the first position, which directs the second connecting member 30 to thereby avoid wobbling of the tool coupler 10. Furthermore, the directing force can be enhanced by one of the two first bends 41 of the first elastic element 40 abutting against the first groove bottom face 211 and the other of the two first bends 41 selectively abutting against the second groove bottom face 311 in response to the swaying movement of the second connecting member 30 relative to the first connecting member 20.

In order to connecting the first connecting member 20 and the second connecting member 30 together, a first lug 22 and a second lug 23 are disposed on an end of the first connecting member 20 along the first rotational axis L1. A first pivotal space 24 is formed between the first lug 22 and the second lug 23. The first groove 21 is formed in a bottom wall of the first pivotal space 24. The first connecting member 20 includes a first through-hole 25 extending in a radial direction perpendicular to the first rotational axis L1. The first through-hole 25 extends through the first lug 22 and the second lug 23. An end of the second connecting member 30 is received in the first pivotal space 24. The second connecting member 30 includes a second through-hole 32 extending in a radial direction perpendicular to the second rotational axis L2 and is connected to a first pin 33. The first pin 33 extends through the first through-hole 25 and the second through-hole 32, such that the second connecting member 30 is pivotably received between the first lug 22 and the second lug 23.

Another end of the second connecting member 30 remote to the first connecting member 20 includes a third groove 34. The third groove 34 includes a third groove bottom face 341 and a third connecting groove 342 in the third groove bottom face 341. The second connecting member 30 includes a third through-hole 35 extending in a radial direction perpendicular to the second rotational axis L2 and is connected to a second pin 36. The tool coupler 10 further includes the body 50 and a second elastic element 60. A third lug 51 and a fourth lug 52 are disposed on an end of the first body 50. A second pivotal space 53 is formed between the third lug 51 and the fourth lug 52. A fourth groove 54 is formed in a bottom wall of the second pivotal space 53. The fourth groove 54 includes a fourth groove bottom face 541 and a fourth connecting groove 542 in the fourth groove bottom face 541. The body 50 includes a fourth through-hole 55 extending through the third lug 51 and the fourth lug 52. The other end of the second connecting member 30 remote to the first connecting member 20 is received in the second pivotal space 53. The second pin 36 extends through the third through-hole 35 and the fourth through-hole 55, such that the second connecting member 30 is pivotably received between the third lug 51 and the fourth lug 52. An end of the second elastic element 60 is inserted into the third connecting groove 342. Another end of the second elastic element 60 is inserted into the fourth connecting groove 542. Furthermore, the control hole 58 may be formed in a sidewall of the third lug 51.

The second elastic element 60 may be in the form of a resilient plate the same as the first elastic element 40 and may include at least one second bend 61 between two opposite ends thereof. The second elastic element 60 includes rectangular cross sections and may include two second bends 61 formed by bending. The two second bends 61 are located on different levels. One of the two second bends 61 of the second elastic element 60 abuts against the third groove bottom face 341. Each of the third groove bottom face 341 and the fourth groove bottom face 541 is arcuate. Furthermore, the curvature of the fourth groove bottom face 541 is smaller than the curvature of the third groove bottom face 341.

Another end of the first connecting member 20 remote to the second connecting member 30 includes a connecting hole 26 configured for coupling with a pneumatic tool (not shown). The connecting hole 26 has square cross sections. An end of the body 50 remote to the second connecting member 30 includes a coupling head 56 configured for coupling with a socket (not shown). The coupling head 56 has square cross sections, and the coupling hole 59 may be formed in a sidewall of the coupling head 56.

In view of the foregoing, a user can simply move the control member 72 of the tool quick-release mechanism according to the present invention with a finger to thereby switch the control member 72 between the coupling position and the release position. When the control member 72 is in the coupling position, the coupling member 73 abuts against the shallower section 7141 and protrudes beyond the coupling hole 59 for coupling with a recessed portion of a to-be-coupled tool. On the other hand, when the control member 72 is in the release position, the coupling member 73 abuts against the deeper section 7142 and does not protrude beyond the coupling hole 59, thereby disengaging from the recessed portion of the to-be-coupled tool, achieving the quick-release effect.

Although specific embodiments have been illustrated and described, numerous modifications and variations are still possible without departing from the scope of the invention. The scope of the invention is limited by the accompanying claims.

1. A tool quick-release mechanism comprising:
a body including a guiding hole extending along a longitudinal axis, a control hole intercommunicating with the guiding hole, and a coupling hole intercommunicating with the guiding hole, and wherein each of the control hole and the coupling hole extends in a radial direction perpendicular to the longitudinal axis and extends through a sidewall of the body; and
a connecting unit including a guiding member movably received in the guiding hole, a control member movably received in the control hole, a coupling member movably received in the coupling hole, and a biasing member disposed between the guiding hole and the guiding member,
wherein the control member is operatively connected to the guiding member, wherein when the control member moves relative to the control hole, the guiding member resists a biasing force of the biasing member and moves relative to the guiding hole, and the coupling member selectively protrudes beyond the coupling hole in response to movement of the guiding member relative to the guiding hole.

2. The tool quick-release mechanism as claimed in claim 1, wherein the control member is movable relative to the control hole in a direction parallel to the longitudinal axis and, thus, switchable between a coupling position and a release position, wherein when the control member is in the coupling position, the coupling member protrudes beyond the coupling hole, and wherein when the control member is in the release position, the coupling member does not protrude beyond the coupling hole.

3. The tool quick-release mechanism as claimed in claim 2, wherein the guiding hole includes a smaller diameter section, a larger diameter section intercommunicating with the smaller diameter section, and a first shoulder formed between the smaller diameter section and the larger diameter section, wherein the guiding member includes a smaller diameter portion, a larger diameter portion connected to the smaller diameter portion, and a second shoulder formed between the smaller diameter portion and the larger diameter portion, and wherein the biasing member includes two opposite ends abutting against the first shoulder and the second shoulder, respectively.

4. The tool quick-release mechanism as claimed in claim 3, wherein the biasing member is a coil spring mounted around the larger diameter portion of the guiding member.

5. The tool quick-release mechanism as claimed in claim 3, wherein the smaller diameter section of the guiding hole extends through a top wall of the body.

6. The tool quick-release mechanism as claimed in claim 3, wherein the guiding member includes a recessed portion defined in an outer periphery of the smaller diameter portion and abutting against the coupling member, wherein the recessed portion includes a shallower section and a deeper section having a depth different from that of the shallower section, wherein when the control member is in the coupling position, the coupling member abuts against the shallower section and protrudes beyond the coupling hole, and wherein when the control member is in the release position, the coupling member abuts against the deeper section and does not protrude beyond the coupling hole.

7. The tool quick-release mechanism as claimed in claim 3, wherein the larger diameter portion of the guiding member includes a first threaded portion extending in a radial direction perpendicular to the longitudinal axis, wherein the control member includes an operating portion and a second threaded portion opposite to the operating portion, wherein the second threaded portion is in threading connection with the first threaded portion, such that the control member is operable to actuate the guiding member to move relative to the guiding hole.

8. The tool quick-release mechanism as claimed in claim 6, wherein the operating portion is located outside of the control hole.
